(19) United States
(12) Patent Application Publication
(10) Pub. No.: US 2013/0285828 A1
(43) Pub. Date: Oct. 31, 2013

(54) SUBMARINE DATA RELAY SYSTEM AND METHOD

(71) Applicant: KOREA INSTITUTE OF GEOSCIENCE & MINERAL RESOURCE, Daejeon (KR)

(72) Inventors: Chi-Ho Yoon, Daejeon (KR); Seok-Ki Kwon, Daejeon (KR); Churl-Hyun Jo, Seoul (KR); Jin-Tae Kim, Daejeon (KR)

(73) Assignee: Korea Institute of Geoscience & Mineral Resources, Daejeon (KR)

(21) Appl. No.: 13/718,781

(22) Filed: Dec. 18, 2012

(30) Foreign Application Priority Data
Apr. 30, 2012 (KR) 10-2012-0045565

(51) Int. Cl. H04Q 9/02

(52) U.S. Cl. CPC H04Q 9/02
USPC 340/850

(57) ABSTRACT

The present invention relates to a submarine data relay system that enables smooth and stable wired data relay without interruption of data transmission even in harsh undersea conditions. The system includes: a main system placed on the water, generating control data and transmitting the control data into water, and collecting data generated in water; a plurality of relay devices placed at different depths, delivering control data from the main system to corresponding sensor units to support measurement, and collecting measurement data from the sensor units and transmitting the measurement data to the main system; an operational line connecting the main system and the relay devices in series for data transmission and power delivery; and an emergency line connecting the main system and every second relay devices, wherein when a break occurs at a section of the operational line, the broken section thereof is replaced with the emergency line.

### BACKGROUND OF THE INVENTION

1. Field of the Invention

The present invention relates to a submarine data relay system and method and, more particularly, to a submarine data relay system and method that enable smooth and stable wired data relay without interruption of data transmission even in harsh undersea conditions.

2. Description of the Related Art

For efficient management of water that is essential for human life and industrial development, structures, such as dams, reservoirs, seawalls, bank, and the like, can be built not only with reinforced concrete, but also in the form of an embankment structure through construction of earth materials such as soil, sand, rock, and the like.

Seabed exploration may be conducted to extract seabed minerals, explore seabed states, survey oceanic fishing resources or investigate various wastes, and is an important part of oceanic research. In littoral seas, such exploration activities have been performed by workers driving exploration equipment or by unmanned exploration vessels.

For seabed exploration and collection, seabed equipment conducting exploration and collection activities is placed on the seabed, and a main system installed on a ship on the water is connected with the seabed equipment through a wire cable.

For deep sea exploration (not for a littoral sea), many relay devices are installed on the wire cable that connects the main system on the water to the seabed equipment. These relay devices transfer control signals from the main system to the seabed equipment and transfer various exploration data from the seabed equipment to the main system to thereby achieve stable data transmission in deep sea exploration and collection. In addition, various sensors installed in the relay devices that are located at different depths of water may sense undersea conditions at their depths of water and report sensing data to the main system on the water. The reported sensing data is used for undersea environment monitoring or exploration activity control.

However, during modern seabed exploration and collection in which many activities are performed at depths exceeding 1000 meters, breaks frequently occur in the cable connecting the water surface and the seabed owing to harsh undersea conditions (influence of tidal currents, changes in sea water pressure, attacks of sea fishes and the like). In the event of a cable break, all activities are stopped, the exploration and collection equipment is lifted to the water surface, the broken cable is replaced, and the exploration and collection equipment is re-laid on the seabed. This occasions great expense and consumes much time.

### SUMMARY OF THE INVENTION

The present invention has been made in view of the above problems and provides a submarine data relay system and method that enable smooth and stable wired data relay without interruption of data transmission even in harsh undersea conditions.

That is, the present invention provides a new submarine data relay system and method wherein, when a break occurs at a section of the operational line owing to harsh undersea conditions, the broken section is immediately replaced with the emergency line so that cost and time needed for equipment recovery or cable replacement may be significantly reduced.

According to an aspect of the present invention, a submarine data relay system includes: a main system placed on the water, generating control data and transmitting the control data into the water, and collecting data generated in the water; a plurality of relay devices placed at different depths of water, delivering control data from the main system to corresponding sensor units to support measurement, and collecting measurement data from the sensor units and transmitting the measurement data to the main system; an operational line connecting the main system and the relay devices in series for data transmission and power delivery; and an emergency line connecting the main system and every second relay devices, wherein when a break occurs at a section of the operational line, the broken section of the operational line is replaced with the emergency line.

The emergency line may connect, for a given relay device not connected to the emergency line, the main system or preceding relay device of the given relay device with the next relay device of the given relay device.

The main system may include: a measurement data analyzer which collects and analyzes measurement data received from the relay devices; a control data generator which generates control data to be sent to the relay devices; a line selector which selects one of the operational line and the emergency line RL connected with the main system for communication; a communication unit which communicates data with the relay devices through the line selected by the line selector; and a break handling signal generator which generates a break handling signal when a break occurs at the operational line linking the relay devices, wherein the break handling signal indicates occurrence of a break at a section of the operational line and activation of the emergency line to replace the broken section of the operational line, and is sent to relay devices belonging to the coverage of the activated emergency line through the communication unit.

Each relay device may include a sensor unit having various sensors for underwater environment monitoring; a control data forwarder connected with the sensor unit and delivering control data from the main system to individual sensors of the sensor unit; a measurement data collector which collects measurement data measured by the sensor unit; a line selector which selects one of the operational line and the emergency line connected with the main system for communication; a communication unit which communicates data with another relay device or the main system through the line selected by the line selector; and a break recognizer which determines occurrence of a line failure, wherein the break recognizer detects occurrence of a break in the operational line connecting the relay device and the next relay device by sending control data to the next relay device and examining arrival of a response signal from the next relay device, and creates, when occurrence of a break is detected, a break report signal and sends the break report signal to the main system.

According to another aspect of the present invention, there is provided a submarine data relay method for a submarine data relay system in which a main system placed on the water and relay devices placed in the water are connected in series through an operational line and the main system and every second relay devices are connected through an emergency line. The method includes: (a) transmitting control data from the main system to the relay devices through the operational line in the downward direction, and transmitting measurement data collected from the relay devices to the main system through the operational line in the upward direction in a manner that the measurement data is accumulated during transmission between relay devices; (b) detecting, by one of the relay devices, occurrence of a break in the operational line and sending a break report signal to the main system; (c) generating, by the main system, a break handling signal, and sending the break handling signal to relay devices belonging to the coverage of the emergency line replacing the broken section of the operational line; and (d) conducting, by relay devices having received the break handling signal, data transmission and power delivery through the activated emergency line.

In detection of occurrence of a break, when a relay device sends control data downwards to the next relay device and fails to receive a response signal from the next relay device, the relay device may determine that a break has occurred at a section of the operational line connecting the relay device and next relay device.

In generation of a break handling signal, the break handling signal may indicate occurrence of a break at a section of the operational line and activation of the emergency line to replace the broken section of the operational line and is sent to relay devices belonging to the coverage of the activated emergency line.

The conducting data transmission and power delivery may include (d-1) selecting, in a case in which a break has occurred at a section of the operational line connecting an upper relay device and a lower relay device and the upper relay device is connected with the emergency line to be activated, by the upper relay device connected with the upward end of the broken section, the emergency line for communication and power delivery in response to a break handling signal; (d-2) sending, by the upper relay device connected with the upward end of the broken section, control data and the break handling signal through the emergency line; and (d-3) sending, by a relay device connected with the downward end of the emergency line in response to the break handling signal, the control data and the break handling signal to the preceding relay device through the operational line, and sending the control data to the next relay device through the operational line.

The conducting data transmission and power delivery further include: (d-4) storing, by the relay device connected with the downward end of the emergency line, measurement data directly obtained and received from the next relay device; (d-5) receiving, by the relay device connected with the downward end of the emergency line, measurement data from the preceding relay device through the operational line; (d-6) sending, by the relay device connected with the downward end of the emergency line, accumulated measurement data through the emergency line; and (d-7) receiving, by the upper relay device connected with the upward end of the broken section, the measurement data through the emergency line, and sending the received measurement data together with directly obtained measurement data to the preceding relay device through the operational line.

The emergency line may connect, for a given relay device connected with the downward end of the broken section of the operational line, the preceding relay device of the given relay device with the next relay device of the given relay device with the exclusion of the given relay device.

The conducting data transmission and power delivery may include: (d-11) selecting, in a case in which a break has occurred at a section of the operational line connecting an upper relay device and a lower relay device and the lower relay device is connected with the emergency line to be activated, by a relay device connected with the upward end of the emergency line, the emergency line and the operational line in the downward direction for communication and power delivery in response to a break handling signal; and (d-12) sending, by the relay device connected with the upward end of the emergency line, control data and the break handling signal through the emergency line and through the operational line in the downward direction.

The conducting data transmission and power delivery may further include: (d-13) sending, by a relay device connected with the downward end of the emergency line, measurement data received from the next relay device and directly obtained measurement data to the relay device connected with the upward end of the emergency line through the emergency line; (d-14) receiving, by the relay device connected with the upward end of the emergency line, measurement data from the next device through the operational line; and (d-15) sending, by the relay device connected with the upward end of the emergency line, the measurement data received through the emergency line and the measurement data received through the operational line together with directly obtained measurement data to the preceding relay device through the operational line.

The emergency line may connect, for a given relay device connected with the upward end of the broken section of the operational line, the preceding relay device of the given relay device with the next relay device of the given relay device with the exclusion of the given relay device.

### BRIEF DESCRIPTION OF THE DRAWINGS

The above and other aspects, features and advantages of the invention will become apparent with reference to the following exemplary embodiments in conjunction with the accompanying drawings, in which;

FIG. 1 illustrates an overview of a submarine data relay system according to an embodiment of the present invention;

FIG. 2 illustrates data relay using the operational line according to an embodiment of the present invention;

FIG. 3 is a block diagram of a main system in the submarine data relay system;

FIG. 4 is a block diagram of a relay device in the submarine data relay system;

FIG. 5 illustrates data relay using the operational line and emergency line according to an embodiment of the present invention; and

FIG. 6 illustrates data relay using the operational line and emergency line according to another embodiment of the present invention.

### DETAILED DESCRIPTION OF THE EXEMPLARY EMBODIMENTS

Exemplary embodiments of the present invention will now be described in detail with reference to the accompanying drawings.

The submarine data relay system of the present invention can be applied to seabed exploration and collection activities, which are conducted to extract seabed minerals, explore seabed states, survey oceanic fishing resources or investigate various wastes. For exploration and collection, seabed equipment conducting exploration and collection activities is placed on the seabed and a main system connected with the seabed equipment through a wire cable is installed on a ship on the water. Many relay devices are separately installed along the wire cable that connects the main system on the water to the seabed equipment on the seabed. These relay devices transfer control signals from the main system to the seabed equipment and transfer various exploration data from the seabed equipment to the main system to thereby achieve stable data transmission in deep sea exploration and collection. In addition, various sensors installed in the relay devices that are located at different depths of water may sense undersea conditions at their depths of water and report sensing data to the main system on the water. The reported sensing data is used for undersea environment monitoring or exploration activity control. Power for sensor operation can be supplied through the wire cable.

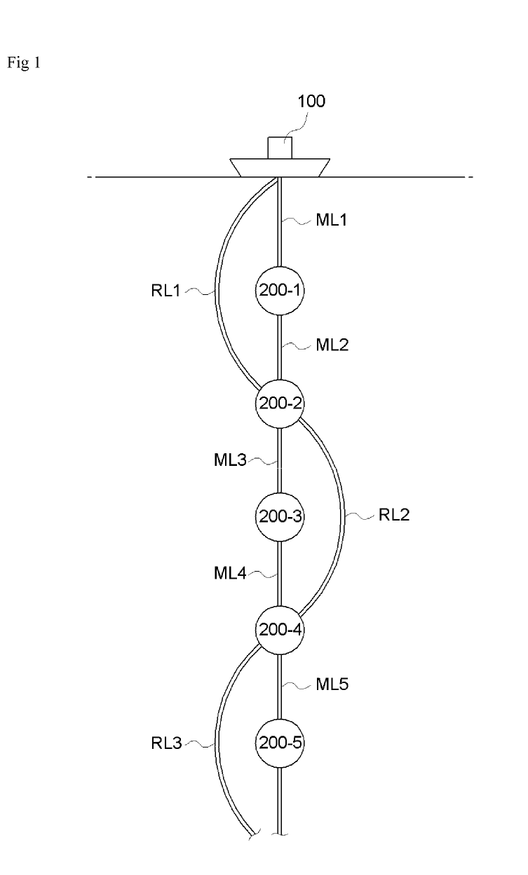

FIG. 1 illustrates an overview of the submarine data relay system according to an embodiment of the present invention.

The submarine data relay system of the present invention includes a main system 100 that is installed on a ship on the water to generate various control data and send the same to the sea water and collect data generated on the seabed, and a plurality of relay devices 200 that relay the control data from the main system 100 toward the seabed and relay data collected on the seabed to the main system 100, wherein the main system 100 is connected with the relay devices 200 through an operational line ML and emergency line RL.

In the present invention, the seabed equipment (not shown) conducting underwater activities may be equipment for extracting seabed minerals, exploring seabed states, surveying oceanic fishing resources, or investigating various kinds of wastes.

The present invention aims to provide a new submarine data relay system and method wherein, when a break occurs at a section of the operational line ML owing to harsh undersea conditions (such as influence of tidal currents, changes in sea water pressure, and attacks of sea fishes), the broken section is immediately replaced with the emergency line RL so that cost and time needed for equipment recovery or cable replacement may be significantly reduced.

Referring to FIG. 1, the main system 100 is installed in the ship on the water and the operational line ML connected to the main system 100 is arranged underwater. That is, one end of the operational line ML is connected to the main system 100 on the water and the other end thereof is connected to the seabed equipment (not shown).

As underwater activities are commonly conducted at depths exceeding 1000 meters, multiple relay devices 200 connected in series to the operational line ML are arranged at regular intervals along the operational line ML. Particularly, in the present invention, the emergency line RL is separately arranged so as to connect every second relay devices 200 with the main system 100.

As shown in FIG. 1, emergency line connection in an every-other fashion is configured so that the first emergency line RL1 connects the main system 100 with the second relay device 200-2 with the exclusion of the first relay device 200-1, and the second emergency line RL2 connects the second relay device 200-2 with the fourth relay device 200-4 with the exclusion of the third relay device 200-3. Here, emergency line connection in an every-other fashion is not limited to FIG. 1, and emergency line connection may be made in various ways depending upon various situations such as underwater conditions and exploration depths.

Control data C generated mainly by the main system 100 is sent to the individual relay devices 200 and used as an operation control signal for various sensors installed therein.

Measurement data M is measurement data obtained by various sensors installed in the relay devices 200.

Control data C generated by the main system 100 is sent downwards to the individual relay devices 200 one after another through the operational line ML. That is, in the downward direction, one relay device 200 extracts control data addressed thereto and forwards the control data C to the next relay device 200 through the operational line ML.

Measurement data M generated at the relay devices 200 is sent upwards to the main system 100 through the operational line ML. In the upward direction, measurement data M generated at one relay device 200 is forwarded through the operational line ML to the next relay device 200 one after another until the main system 100 is reached.

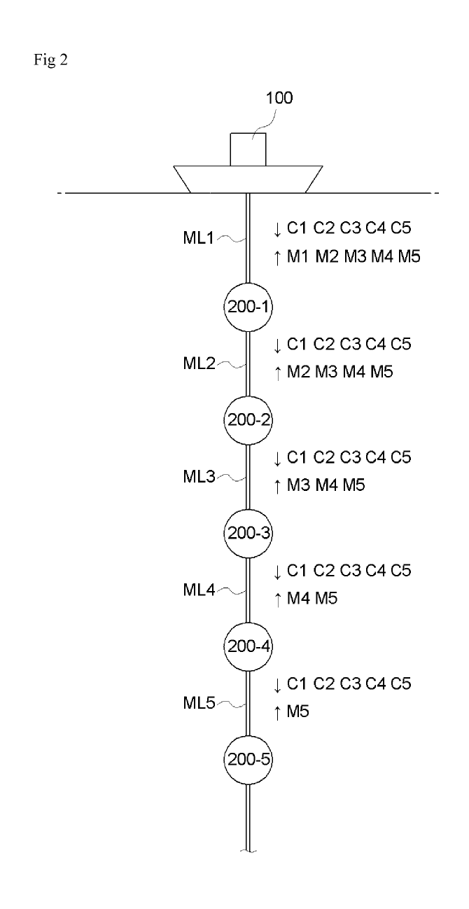

Data relay using the operational line ML in normal situations is described with reference to FIG. 2.

Referring to FIG. 2, the main system 100 generates control data C1, C2, C3, C4 and C5 for all relay devices 200 and sends the control data C1, C2, C3, C4 and C5 downwards through the first operational line ML1. The first relay device 200-1 receives the control data C1, C2, C3, C4 and C5 through the first operational line ML1, extracts first control data C1 addressed thereto to control related sensors, and sends the control data C1, C2, C3, C4 and C5 downwards through the second operational line ML2. The second relay device 200-2 receives the control data C1, C2, C3, C4 and C5 through the second operational line ML2, extracts second control data C2 addressed thereto to control related sensors, and sends the control data C1, C2, C3, C4 and C5 downwards through the third operational line ML3. This downward relay is repeated until the control data reaches the last relay device (fifth relay device 200-5 in FIG. 2).

In addition, the fifth relay device 200-5 collects measurement data M5 at its depth of water using related sensors, and sends the measurement data M5 upwards through the fifth operational line MLS. The fourth relay device 200-4 collects measurement data M4 at its depth of water using related sensors, and sends the measurement data M4 together with the measurement data M5 from the fifth relay device 200-5 upwards through the fourth operational line ML4. The third relay device 200-3 collects measurement data M3 at its depth of water using related sensors, and sends the measurement data M3 together with the measurement data M4 and M5 from the fourth relay device 200-4 upwards through the third operational line ML3. This upward relay is repeated until the measurement data reaches the main system 100.

In normal situations, these downward control data relay and upward measurement data relay are performed through the operational line ML.

When a break occurs at a section of the operational line linking the water surface and the seabed owing to harsh undersea conditions (such as influence of tidal currents, changes in sea water pressure, and attacks of sea fishes), downward control data relay and upward measurement data relay cannot be performed normally.

To handle the above problem, in the present invention, the emergency line RL is separately provided so as to connect every second relay devices 200 with the main system 100.

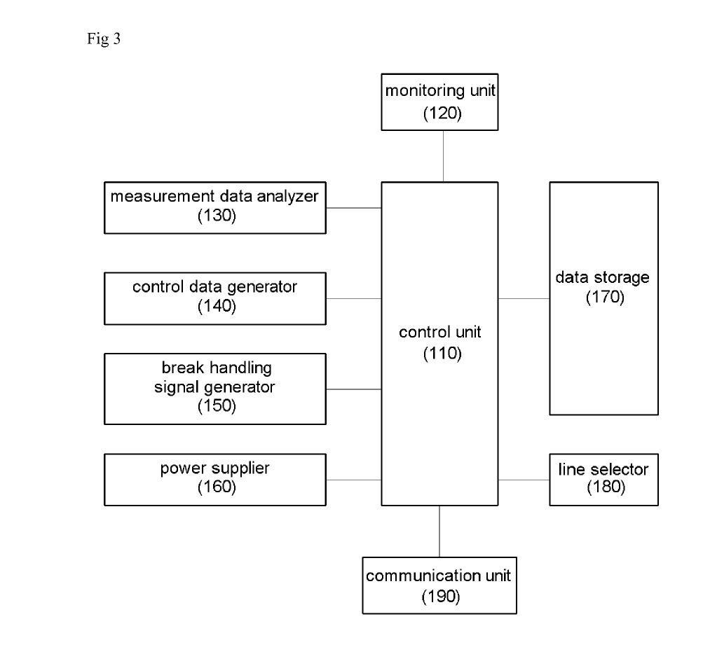

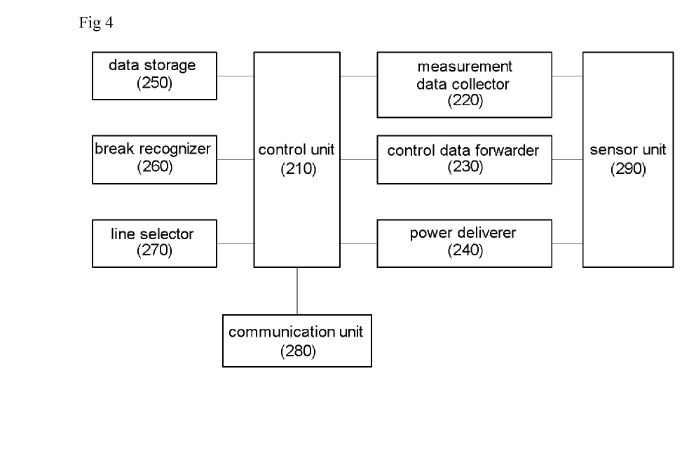

Next, a description is given of the submarine data relay system that automatically initiates, when a break occurs at a section of the operational line ML linking the water surface and the seabed, data relay using the emergency line RL at the broken section in connection with FIGS. 3 and 4.

FIG. 3 is a block diagram of the main system 100 in the submarine data relay system, and FIG. 4 is a block diagram of one relay device 200 therein.

Referring to FIG. 3, the main system 100 may include a measurement data analyzer 130 which collects and analyzes measurement data M received from the relay devices 200, a control data generator 140 which generates control data C to be sent to the relay devices 200, a break handling signal generator 150 which generates a break handling signal when a failure such as a break occurs at the operational line ML linking the relay devices 200, a power supplier 160 which supplies necessary power to the relay devices 200, a data storage 170 which stores and manages measurement data M received from the measurement data analyzer 130, a monitoring unit 120 which displays analysis results obtained by the measurement data analyzer 130, a line selector 180 which selects one of the operational line ML and the emergency line RL connected with the main system 100 for communication, a communication unit 190 which communicates data with the relay devices 200, and a control unit 110 which controls the above components.

The measurement data analyzer 130 collects measurement data M from the relay devices 200 and analyzes the collected measurement data M. The measurement data M is obtained from sensors installed in the individual relay devices 200 placed at different depths of water. The measurement data M may be various environmental measurement data, such as depth measurement data, seawater pressure measurement data, seawater temperature measurement data, seawater salinity measurement data, oxygen measurement data, turbidity measurement data, hydrogen ion concentration measurement data, flow rate measurement data, discharge measurement data, and slope measurement data. The measurement data M may also include activity related data sent by the seabed equipment conducting exploration and collection activities on the seabed.

In the description, reference symbols M1, M2, M3, M4 and M5 refer to measurement data measured at the first relay device 200-1, second relay device 200-2, third relay device 200-3, fourth relay device 200-4 and fifth relay device 200-5, respectively.

The control data generator 140 generates control data C to be sent to the relay devices 200. Here, the control data C is control data to be sent to the individual relay devices 200 placed at different depths. The control data C may include various sensor control data, such as sensor initiation data, sensor operation condition data and sensor measurement condition compensation data, and include control data for the relay devices 200. The control data C may also include control data for the seabed equipment conducting exploration and collection activities on the seabed.

In the description, reference symbols C1, C2, C3, C4 and C5 refer to control data destined for the first relay device 200-1, second relay device 200-2, third relay device 200-3, fourth relay device 200-4 and fifth relay device 200-5, respectively.

The break handling signal generator 150 receives a break report from a relay device 200 near a section of the operational line ML at which a failure such as a break has occurred, and generates a break handling signal and sends the same to the relay device 200 near to the broken section. The break handling signal is sent together with information on the emergency line RL to be used instead of the broken section of the operational line ML. In addition, when a break has occurred at a section of the operational line ML directly connected to the main system 100, the break handling signal generator 150 sends a break handling signal to the line selector 180 via the control unit 110, so that the emergency line RL can be used for communication instead of the broken operational line ML.

The power supplier 160 supplies power for operating sensors of each relay device 200, and for the seabed equipment. Hence, the operational line ML and the emergency line RL are preferably a composite cable composed of a fiber optic cable for data transmission and a conductor cable for power delivery. Each relay device 200 may have a voltage converter to supply suitable driving power to sensors.

The data storage 170 stores measurement data M received from the measurement data analyzer 130. Here, the measurement data M may be managed according to depth or relay devices. The data storage 170 may also store control data C to be sent to relay devices, and further store data related to the seabed equipment conducting exploration and collection activities on the seabed.

The monitoring unit 120 displays analysis results obtained by the measurement data analyzer 130.

The line selector 180 selects one of the operational line ML and the emergency line RL connected with the main system 100 for communication and power delivery. The line selector 180 performs line selection under control of the break handling signal generator 150.

The communication unit 190 enables exchange of control data C, measurement data M, break reports, and break handling signals between the main system 100 and the relay devices 200.

Referring to FIG. 4, a relay device 200 connected with the main system 100 through the operational line ML or the emergency line RL is connected to a sensor unit 290 including various sensors for underwater environment monitoring, and forwards control data C from the main system 100 to the sensor unit 290 and forwards measurement data M collected from the sensor unit 290 to the main system 100.

Here, measurement data collected from the sensor unit 290 may include various environmental measurement data, such as depth measurement data, seawater pressure measurement data, seawater temperature measurement data, seawater salinity measurement data, oxygen measurement data, turbidity measurement data, hydrogen ion concentration measurement data, flow rate measurement data, discharge measurement data, and slope measurement data.

The relay device 200 may include a measurement data collector 220 to collect data measured by individual sensors of the sensor unit 290, a control data forwarder 230 to deliver control data to individual sensors of the sensor unit 290, a power deliverer 240 to supply necessary power to individual sensors of the sensor unit 290, a data storage 250 to store measurement data from sensors of the sensor unit 290 and control data to be sent to the sensors, a break recognizer 260 to determine occurrence of a line failure, a line selector 270 to select one of the operational line ML and the emergency line RL connected with the main system 100 for communication, a communication unit 280 to communicate data with another relay device 200 or the main system 100, and a control unit 210 to control the above components.

The measurement data collector 220 collects various measurement data from individual sensors of the sensor unit 290. Here, the measurement data collected from the sensor unit 290 may include various environmental measurement data, such as depth measurement data, seawater pressure measurement data, seawater temperature measurement data, seawater salinity measurement data, oxygen measurement data, turbidity measurement data, hydrogen ion concentration measurement data, flow rate measurement data, discharge measurement data, and slope measurement data.

The control data forwarder 230 extracts control data destined for the relay device 200 from control data sent by the main system 100 and delivers the extracted control data to the sensor unit 290. Here, the control data may include various sensor control data, such as sensor initiation data, sensor operation condition data and sensor measurement condition compensation data.

The power deliverer 240 draws electric power from the line and supplies necessary power to the sensor unit 290 for operating individual sensors. Each relay device 200 may have a voltage converter to supply suitable driving power to sensors.

The data storage 250 stores measurement data from sensors of the sensor unit 290 and control data to be sent to the sensors. Specifically, the data storage 250 stores all control data C1, C2, C3, C4, C5 . . . destined for all relay devices 200 and stores measurement data generated by the present relay device 200 and subsequent relay devices 200 in the downward direction.

The break recognizer 260 determines occurrence of a break in the operational line ML by sending control data C received from the preceding relay device 200 to the next relay device 200 and examining arrival of a response signal as a reply to the control data C.

For example, in FIG. 1, the second relay device 200-2 sends control data received from the preceding relay device to the third relay device 200-3 through the third operational line ML3. When the third relay device 200-3 successfully receives the control data, it sends a response signal to the second relay device 200-2. In the event that the second relay device 200-2 fails to receive such a response signal, the break recognizer 260 thereof determines that the third operational line ML3 is broken, creates a break report signal e-ML3 indicating the third operational line ML3, and sends the break report signal e-ML3 to the main system 100 via the preceding relay device.

The line selector 270 selects one of the operational line ML and the emergency line RL connected with the relay device 200 for communication and power delivery. The line selector 270 performs line selection under control of the break handling signal generator 150 of the main system 100.

The communication unit 280 enables exchange of control data C, measurement data M, break reports, and break handling signals with the main system 100 or neighboring relay devices 200.

Hereinafter, the submarine data relay method of the present invention is described in detail.

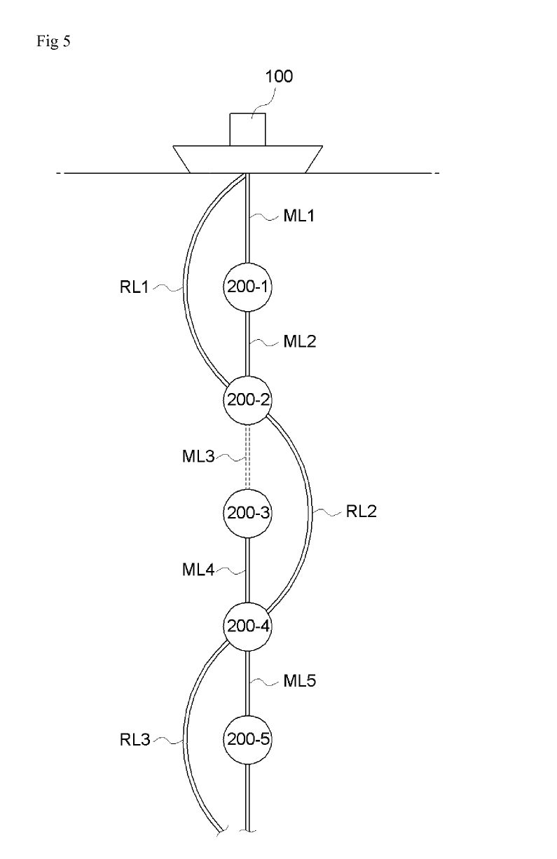

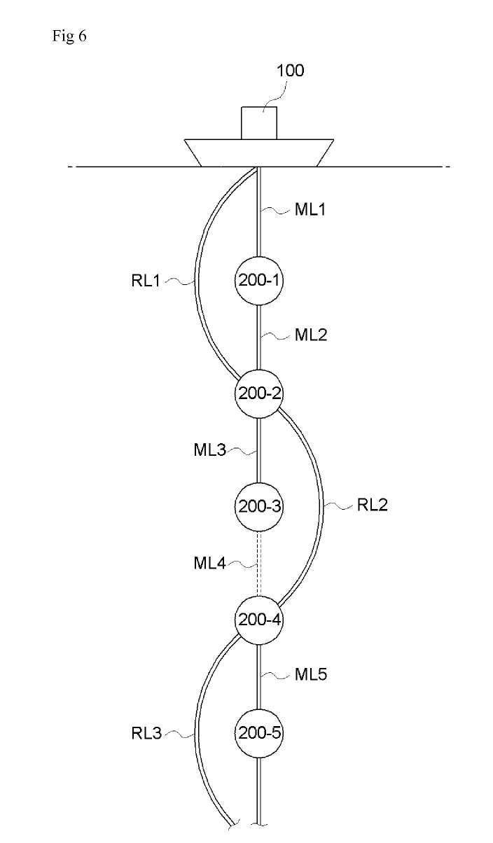

Data relay using the operational line ML in normal situations is described with reference to FIG. 2. Next, a description is given of data relay using the operational line ML and the emergency line RL in the event of a break at a section of the operational line ML with reference to FIGS. 5 and 6.

FIG. 5 depicts a case in which a break occurs at a section of the operational line ML connecting an upper relay device 200 and a lower relay device 200 and the upper relay device 200 is connected with the emergency line RL. FIG. 6 depicts a case in which a break occurs at a section of the operational line ML connecting an upper relay device 200 and a lower relay device 200 and the lower relay device 200 is connected with the emergency line RL.

In FIG. 5, a break has occurred at the third operational line ML3 connecting the second relay device 200-2 and the third relay device 200-3, and the second relay device 200-2 (upward end of the broken third operational line ML3) is connected with the second emergency line RL2.

In normal situations, the main system 100 generates control data C1, C2, C3, C4 and C5 for all relay devices 200 and sends the control data C1, C2, C3, C4 and C5 downwards through the first operational line ML1. The first relay device 200-1 receives the control data C1, C2, C3, C4 and C5 through the first operational line ML1, extracts first control data C1 addressed thereto to control related sensors, and sends the control data C1, C2, C3, C4 and C5 downwards through the second operational line ML2.

The second relay device 200-2 sends the control data C1, C2, C3, C4 and C5 downwards to the third relay device 200-3 through the third operational line ML3. When the third relay device 200-3 successfully receives the control data C1, C2, C3, C4 and C5, it sends a response signal to the second relay device 200-2. In the event that the second relay device 200-2 fails to receive such a response signal, the break recognizer 260 of the second relay device 200-2 determines that the third operational line ML3 is broken.

The break recognizer 260 of the second relay device 200-2 creates a break report signal e-ML3 indicating the third operational line ML3, and sends the break report signal e-ML3 to the main system 100.

Upon reception of the break report signal e-ML3, the break handling signal generator 150 of the main system 100 generates a break handling signal (A-RL2, DC-ML3).

Here, the break handling signal (A-RL2, DC-ML3) indicates occurrence of a break in the third operational line ML3 and activation of the second emergency line RL2 to replace the third operational line ML3.

The main system 100 sends the break handling signal (A-RL2, DC-ML3) through the communication unit 190 to the second relay device 200-2, the third relay device 200-3 and the fourth relay device 200-4 belonging to the coverage of the second emergency line RL2.

After the second relay device 200-2 receives the break handling signal (A-RL2, DC-ML3) via the preceding relay device, the line selector 270 thereof selects the second emergency line RL2 for communication and power delivery among the third operational line ML3 and the second emergency line RL2 connected with the second relay device 200-2 in the downward direction.

After the fourth relay device 200-4 receives the break handling signal (A-RL2, DC-ML3), the line selector 270 thereof selects both the fourth operational line ML4 and the second emergency line RL2 connected with the fourth relay device 200-4 in the upward direction, for communication and power delivery.

After the third relay device 200-3 receives the break handling signal (A-RL2, DC-ML3), the line selector 270 thereof selects the fourth emergency line RL4 for communication and power delivery among the third operational line ML3 connected with the third relay device 200-3 in the upward direction and the fourth emergency line RL4 connected with the third relay device 200-3 in the downward direction.

That is, the fourth relay device 200-4 selects the second emergency line RL2 to connect to the second relay device 200-2, and selects the fourth operational line ML4 to connect to the third relay device 200-3.

Hence, control data C1, C2, C3, C4 and C5 from the main system 100 can be sent from the second relay device 200-2 through the second emergency line RL2 to the fourth relay device 200-4; and the control data C1, C2, C3, C4 and C5 can be sent further from the fourth relay device 200-4 not only through the fifth operational line ML5 to the fifth relay device 200-5 but also through the fourth operational line ML4 to the third relay device 200-3 (in the upward direction). Thereby, control data can be normally delivered to all the relay devices even though the third operational line ML3 has broken. Here, the control data may be delivered from the fourth relay device 200-4 to the third relay device 200-3 together with the break handling signal (A-RL2, DC-ML3).

After reception of the break handling signal (A-RL2, DC-ML3), the third relay device 200-3 sends measurement data M3 obtained by the sensor unit to the fourth relay device 200-4 through the fourth operational line ML4.

The fourth relay device 200-4 sends measurement data M3, M4 and M5 (data from the third relay device 200-2, data obtained directly by the sensor unit, and data from the fifth relay device 200-5) to the second relay device 200-2 through the second emergency line RL2.

Hence, measurement data obtained by every relay device can be normally delivered to the main system 100 even though the third operational line ML3 has broken.

In FIG. 6, a break has occurred at the fourth operational line ML4 connecting the third relay device 200-3 and the fourth relay device 200-4, and the fourth relay device 200-4 (downward end of the broken fourth operational line ML4) is connected with the second emergency line RL2.

In this case, the third relay device 200-3 sends control data C1, C2, C3, C4 and C5 downwards to the fourth relay device 200-4 through the fourth operational line ML4. When the fourth relay device 200-4 successfully receives the control data C1, C2, C3, C4 and C5, it sends a response signal to the third relay device 200-3. In the event that the third relay device 200-3 fails to receive such a response signal, the break recognizer 260 of the third relay device 200-3 determines that the fourth operational line ML4 is broken.

The break recognizer 260 of the third relay device 200-3 creates a break report signal e-ML4 indicating the fourth operational line ML4, and sends the break report signal e-ML4 to the main system 100.

Upon reception of the break report signal e-ML4, the break handling signal generator 150 of the main system 100 generates a break handling signal (A-RL2, DC-ML4).

Here, the break handling signal (A-RL2, DC-ML4) indicates occurrence of a break at the fourth operational line ML4 and activation of the second emergency line RL2 to replace the fourth operational line ML4.

The main system 100 sends the break handling signal (A-RL2, DC-ML4) through the communication unit 190 to the second relay device 200-2, the third relay device 200-3 and the fourth relay device 200-4 belonging to the coverage of the second emergency line RL2.

After the second relay device 200-2 receives the break handling signal (A-RL2, DC-ML4) via the preceding relay device, the line selector 270 thereof selects both the third operational line ML3 and the second emergency line RL2 connected with the second relay device 200-4 in the downward direction, for communication and power delivery.

After the fourth relay device 200-4 receives the break handling signal (A-RL2, DC-ML4), the line selector 270 thereof selects the second emergency line RL2 for communication and power delivery among the fourth operational line ML4 and the second emergency line RL2 connected with the fourth relay device 200-4 in the upward direction.

After the third relay device 200-3 receives the break handling signal (A-RL2, DC-ML4), the line selector 270 thereof selects only the third emergency line RL3 for communication and power delivery among the third operational line ML3 connected with the third relay device 200-3 in the upward direction and the fourth emergency line RL4 connected with the third relay device 200-3 in the downward direction.

That is, the second relay device 200-2 selects the second emergency line RL2 to connect to the fourth relay device 200-4, and selects the third operational line ML3 to connect to the third relay device 200-3.

Hence, control data C1, C2, C3, C4 and C5 from the main system 100 can be sent from the second relay device 200-2 not only through the second emergency line RL2 to the fourth relay device 200-4 but also through the third operational line ML3 to the third relay device 200-3; and the control data C1, C2, C3, C4 and C5 can be sent further from the fourth relay device 200-4 through the fifth operational line ML5 to the fifth relay device 200-5. Thereby, control data can be normally delivered to all the relay devices even though the fourth operational line ML4 has broken. Here, the control data may be delivered from the second relay device 200-2 to the third relay device 200-3 together with the break handling signal (A-RL2, DC-ML4), and the control data may be delivered from the second relay device 200-2 to the fourth relay device 200-4 together with the break handling signal (A-RL2, DC-ML4).

After reception of the break handling signal (A-RL2, DC-ML4), the third relay device 200-3 sends measurement data M3 obtained by the sensor unit to the second relay device 200-2 through the third operational line ML3.

After reception of the break handling signal (A-RL2, DC-ML4), the fourth relay device 200-4 sends measurement data M4 and M5 (data obtained directly by the sensor unit, and data from the fifth relay device 200-5) to the second relay device 200-2 through the second emergency line RL2.

The second relay device 200-2 sends measurement data M2, M3, M4 and M5 (data obtained directly by the sensor unit, data from the third relay device 200-2, data from the fourth relay device 200-4, and data from the fifth relay device 200-5) to the first relay device 200-1 in the upward direction.

Hence, measurement data obtained by every relay device can be normally delivered to the main system 100 even though the fourth operational line ML4 has broken.

As such, according to the present invention, it is possible to conduct smooth and stable wired data relay without interruption of data transmission even in harsh undersea conditions.

Some exemplary embodiments have been disclosed in the specification and drawings. It should be understood that the terms used in these embodiments are provided for the purpose of illustration and are not intended to limit the scope of the invention set forth in the accompanying claims. Therefore, it will be apparent to those skilled in the art that various modifications, changes, alterations, and equivalent embodiments can be made without departing from the spirit and scope of the invention. The scope of the invention should be limited only by the accompanying claims and equivalents thereof.

What is claimed is:

1. A submarine data relay system comprising:
a main system placed on the water, generating control data and transmitting the control data into the water, and collecting data generated in the water;
a plurality of relay devices placed at different depths of water, delivering control data from the main system to corresponding sensor units to support measurement, and collecting measurement data from the sensor units and transmitting the measurement data to the main system;
an operational line connecting the main system and the relay devices in series for data transmission and power delivery; and
an emergency line connecting the main system and every second relay devices,
the broken section of the operational line being replaced with the emergency line when a break occurs at a section of the operational line.

2. The submarine data relay system of claim 1, wherein the emergency line connects, for a given relay device not connected to the emergency line, the main system or preceding relay device of the given relay device with the next relay device of the given relay device.

3. The submarine data relay system of claim 1, wherein the main system comprises:
a measurement data analyzer which collects and analyzes measurement data received from the relay devices;
a control data generator which generates control data to be sent to the relay devices;
a line selector which selects one of the operational line and the emergency line RL connected with the main system for communication;
a communication unit which communicates data with the relay devices through the line selected by the line selector; and
a break handling signal generator which generates a break handling signal when a break occurs at the operational line linking the relay devices, wherein the break handling signal indicates occurrence of a break at a section of the operational line and activation of the emergency line to replace the broken section of the operational line, and is sent to relay devices belonging to the coverage of the activated emergency line through the communication unit.

4. The submarine data relay system of claim 1, wherein each relay device comprises:
a sensor unit having various sensors for underwater environment monitoring;
a control data forwarder connected with the sensor unit and delivering control data from the main system to individual sensors of the sensor unit;
a measurement data collector which collects measurement data measured by the sensor unit;
a line selector which selects one of the operational line and the emergency line connected with the main system for communication;
a communication unit which communicates data with another relay device or the main system through the line selected by the line selector; and
a break recognizer which determines occurrence of a line failure, wherein the break recognizer detects occurrence of a break in the operational line connecting the relay device and the next relay device by sending control data to the next relay device and examining arrival of a response signal from the next relay device, and creates, when occurrence of a break is detected, a break report signal and sends the break report signal to the main system.

5. A submarine data relay method, for a submarine data relay system in which a main system placed on the water and relay devices placed in the water are connected in series through an operational line and the main system and every second relay devices are connected through an emergency line, the method comprising:
(a) transmitting control data from the main system to the relay devices through the operational line in the downward direction, and transmitting measurement data collected from the relay devices to the main system through the operational line in the upward direction in a manner that the measurement data is accumulated during transmission between relay devices;
(b) detecting, by one of the relay devices, occurrence of a break in the operational line and sending a break report signal to the main system;
(c) generating, by the main system, a break handling signal, and sending the break handling signal to relay devices belonging to the coverage of the emergency line replacing the broken section of the operational line; and
(d) conducting, by relay devices having received the break handling signal, data transmission and power delivery through the activated emergency line.

6. The submarine data relay method of claim 5, wherein, in detection of occurrence of a break, when a relay device sends control data downwards to the next relay device and fails to receive a response signal from the next relay device, the relay device determines that a break has occurred at a section of the operational line connecting the relay device and next relay device.

7. The submarine data relay method of claim 5, wherein, in the generating a break handling signal, the break handling signal indicates occurrence of a break at a section of the operational line and activation of the emergency line to replace the broken section of the operational line and is sent to relay devices belonging to the coverage of the activated emergency line.

8. The submarine data relay method of claim 5, wherein the conducting data transmission and power delivery comprises:
(d-1) selecting, in a case in which a break has occurred at a section of the operational line connecting an upper relay device and a lower relay device and the upper relay device is connected with the emergency line to be activated, by the upper relay device connected with the upward end of the broken section, the emergency line for communication and power delivery in response to a break handling signal;
(d-2) sending, by the upper relay device connected with the upward end of the broken section, control data and the break handling signal through the emergency line; and
(d-3) sending, by a relay device connected with the downward end of the emergency line in response to the break handling signal, the control data and the break handling signal to the preceding relay device through the operational line, and sending the control data to the next relay device through the operational line.

9. The submarine data relay method of claim 8, wherein the conducting data transmission and power delivery further comprises:
(d-4) storing, by the relay device connected with the downward end of the emergency line, measurement data directly obtained and received from the next relay device;
(d-5) receiving, by the relay device connected with the downward end of the emergency line, measurement data from the preceding relay device through the operational line;
(d-6) sending, by the relay device connected with the downward end of the emergency line, accumulated measurement data through the emergency line; and
(d-7) receiving, by the upper relay device connected with the upward end of the broken section, the measurement data through the emergency line, and sending the received measurement data together with directly obtained measurement data to the preceding relay device through the operational line.

10. The submarine data relay method of claim 8 or 9, wherein the emergency line connects, for a given relay device connected with the downward end of the broken section of the operational line, the preceding relay device of the given relay device with the next relay device of the given relay device with the exclusion of the given relay device.

11. The submarine data relay method of claim 5, wherein the conducting data transmission and power delivery comprises:
(d-11) selecting, in a case in which a break has occurred at a section of the operational line connecting an upper relay device and a lower relay device and the lower relay device is connected with the emergency line to be activated, by a relay device connected with the upward end of the emergency line, the emergency line and the operational line in the downward direction for communication and power delivery in response to a break handling signal; and
(d-12) sending, by the relay device connected with the upward end of the emergency line, control data and the break handling signal through the emergency line and through the operational line in the downward direction.

12. The submarine data relay method of claim 11, wherein the conducting data transmission and power delivery further comprises:
(d-13) sending, by a relay device connected with the downward end of the emergency line, measurement data received from the next relay device and directly obtained measurement data to the relay device connected with the upward end of the emergency line through the emergency line;
(d-14) receiving, by the relay device connected with the upward end of the emergency line, measurement data from the next device through the operational line; and
(d-15) sending, by the relay device connected with the upward end of the emergency line, the measurement data received through the emergency line and the measurement data received through the operational line together with directly obtained measurement data to the preceding relay device through the operational line.

13. The submarine data relay method of claim 11 or 12, wherein the emergency line connects, for a given relay device connected with the upward end of the broken section of the operational line, the preceding relay device of the given relay device with the next relay device of the given relay device with the exclusion of the given relay device.
